(19) United States
(12) Patent Application Publication
(10) Pub. No.: US 2020/0005642 A1
(43) Pub. Date: Jan. 2, 2020

(54) METHOD AND APPARATUS FOR MOVING A PARKED VEHICLE FOR AN EMERGENCY VEHICLE IN AUTONOMOUS DRIVING SYSTEM

(71) Applicant: LG ELECTRONICS INC., Seoul (KR)

(72) Inventor: Joonghang KIM, Seoul (KR)

(73) Assignee: LG ELECTRONICS INC., Seoul (KR)

(21) Appl. No.: 16/569,408

(22) Filed: Sep. 12, 2019

(30) Foreign Application Priority Data
Aug. 15, 2019 (KR) 10-2019-0099979

(51) Int. Cl. G08G 1/14; B60W 30/06; B60W 30/095; G08G 1/16; B62D 15/02; G05D 1/02; H04W 4/90

(52) U.S. Cl. CPC G08G 1/145; B60W 30/06; B60W 30/0956; B60W 2550/408; B62D 15/0285; G05D 1/0214; H04W 4/90; G08G 1/168

(57) ABSTRACT

A method for moving a parked vehicle for an emergency vehicle in autonomous driving systems searches for a route connecting a location of the emergency vehicle and an emergency occurrence spot, determines whether the route is available with respect to the parked vehicle, requests information about a movement capability of the parked vehicle when the route is not available for the emergency vehicle, receives the information about the movement capability from the parked vehicle, sets a state of the route on the basis of the information about the movement capability, determines an optimal route set to a state indicating availability and providing a shortest estimated time of arrival at the emergency occurrence spot, and transmits information about the optimal route to the emergency vehicle, thereby moving the parked vehicle and using the optimal route. One or more of an autonomous vehicle, a user terminal and a server of the present disclosure can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATION

Pursuant to 35 U.S.C. § 119(a), this application claims the benefit of earlier filing date and right of priority to Korean Patent Application No. 10-2019-0099979, filed on Aug. 15, 2019, the contents of which are hereby incorporated by reference herein in its entirety.

### BACKGROUND OF THE INVENTION

### Field of the Invention

The present disclosure relates to an autonomous driving system and, more particularly, to a method for moving a parked vehicle located on a travel route of an emergency vehicle and an apparatus therefor.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present disclosure is to provide a method for moving a parked vehicle for an emergency vehicle.

Further, an object of the present disclosure is to provide a method for moving, by a user, a parked vehicle for an emergency vehicle through a terminal

It will be appreciated by persons skilled in the art that the objects that could be achieved with the present disclosure are not limited to what has been particularly described hereinabove and the above and other objects that the present disclosure could achieve will be more clearly understood from the following detailed description.

In one aspect of the present disclosure, a method for moving a parked vehicle for an emergency vehicle in autonomous driving systems may include: searching for a route connecting a location of the emergency vehicle and an emergency occurrence spot; determining whether the route is available with respect to the parked vehicle; requesting information about a movement capability of the parked vehicle when the route is not available for the emergency vehicle; receiving the information about the movement capability from the parked vehicle; setting a state of the route on the basis of the information about the movement capability and determining an optimal route set to a state indicating availability and providing a shortest estimated time of arrival at the emergency occurrence spot; and transmitting information about the optimal route to the emergency vehicle, wherein the information about the movement capability may indicate whether the parked vehicle can move according to autonomous driving, the availability may indicate that the emergency vehicle can pass through the route according to movement of the parked vehicle, and the emergency vehicle may move to the emergency occurrence spot through the optimal route.

Further, the method may further include: transmitting a request message for requesting dispatch of the emergency vehicle; receiving a response message to the request message from the emergency vehicle; and determining the emergency vehicle on the basis of the response message, wherein the request message may be transmitted to one or more emergency vehicles and the response message may include positional information of the emergency vehicle.

Further, the method may further include transmitting a movement request message to the parked vehicle, wherein the movement request message may be for moving the parked vehicle parked on the optimal route.

Further, the method may further include transmitting positional information of a parking lot to which the parked vehicle can move and parking space information of the parking lot to the parked vehicle, wherein the movement capability may be set by the parked vehicle on the basis of the positional information and the parking space information.

Further, the method may further include transmitting information about the route to the emergency vehicle when the route is available for the emergency vehicle, wherein the emergency vehicle may move to the emergency occurrence spot through the route.

Further, the information about the movement capability may indicate movement unavailability when a battery state for movement of the parked vehicle is not sufficient or the parked vehicle does not support autonomous driving.

Further, the information about the movement capability may include positional information of the parked vehicle, and the movement capability may be reset by a server on the basis of the positional information of the parked vehicle.

Further, it may be determined whether the parked vehicle is movable through a UE of a user.

Further, a parking lot available for the parked vehicle may be set through a UE of a user.

Further, the method may further include transmitting a message for moving the parked vehicle to a UE of a user of the parked vehicle when the optimal route is not determined.

In another aspect of the present disclosure, a method for moving a parked vehicle, by a UE, for an emergency vehicle in autonomous driving systems may include: receiving, from the parked vehicle, an alarm message indicating that movement of the parked vehicle has been requested; displaying the alarm message on a display of the UE; receiving a permission of movement of the parked vehicle from a user through an input button displayed on the display; and transmitting a permission message indicating the permission of movement to the parked vehicle, wherein the alarm message may include a time estimated to be taken for the emergency vehicle to arrive at a location of the parked vehicle, and the parked vehicle may perform a movement operation on the basis of the permission message.

Further, the method may further include: receiving information about parking lots available for the parked vehicle from the parked vehicle; and displaying the information about the parking lots on the display, wherein the information about the parking lots may include positional information, names and the number of available parking spaces of the parking lots, and the parked vehicle can arrive at the parking lots through autonomous driving.

Further, the displaying of the information about the parking lots may include displaying a list including the names of the parking lots on the display.

Further, the method may further include: selecting a parking lot to which the parked vehicle will move by the user through an input button displayed on the display; and transmitting, to the parked vehicle, information about the parking lot to which the parked vehicle will move, wherein the parked vehicle may perform a movement operation on the basis of information on the parking lot to which the parked vehicle will move.

Further, the method may further include: receiving parking state information from the parked vehicle; and displaying a position at which the parked vehicle is parked on a map through the display on the basis of the parking state information, wherein the parking state information may include information on the position at which the parked vehicle is parked.

In another aspect of the present disclosure, a UE for moving a parked vehicle for an emergency vehicle in autonomous driving systems may include: a communication module; a display; a memory; and a processor configured to control the communication module, the display and the memory, wherein the processor may be configured: to receive, from the parked vehicle, an alarm message indicating that movement of the parked vehicle has been requested through the communication module; to display the alarm message on the display; to receive a permission of movement of the parked vehicle from a user through an input button displayed on the display; and to transmit a permission message indicating the permission of movement to the parked vehicle through the communication module, wherein the alarm message may include a time estimated to be taken for the emergency vehicle to arrive at a location of the parked vehicle, and the parked vehicle may perform a movement operation on the basis of the permission message.

According to an embodiment of the present disclosure, it is possible to move a parked vehicle for an emergency vehicle.

Furthermore, according to an embodiment of the present disclosure, a user can move a parked vehicle for an emergency vehicle through a UE.

It will be appreciated by persons skilled in the art that the effects that could be achieved with the present disclosure are not limited to what has been particularly described hereinabove and the above and other effects that the present disclosure could achieve will be more clearly understood from the following detailed description.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram for describing a use scenario of a user according to an embodiment of the present disclosure.

FIG. 10 illustrates V2X communication to which the present disclosure is applicable.

FIG. 11 illustrates a resource allocation method in a sidelink in which V2X is used.

FIG. 12 is a diagram illustrating a procedure for a broadcast mode of V2X communication using PCS.

FIG. 13 shows an embodiment to which the present disclosure is applicable.

FIG. 14 shows an embodiment to which the present disclosure is applicable.

FIG. 15 illustrates an operation of a parked vehicle to which the present disclosure is applicable.

FIG. 16 shows an embodiment of a terminal to which the present disclosure is applicable.

FIG. 17 shows an embodiment of a server to which the present disclosure is applicable.

FIG. 18 illustrates a method of setting movement capability of a vehicle to which the present disclosure is applicable.

FIG. 19 illustrates an apparatus to which the present disclosure is applicable.

FIG. 20 is a block diagram of a communication apparatus according to an embodiment of the present disclosure.

The accompanying drawings, which are included to provide a further understanding of the invention and are incorporated in and constitute a part of this specification, illustrate embodiments of the invention and together with the description serve to explain the principles of the invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

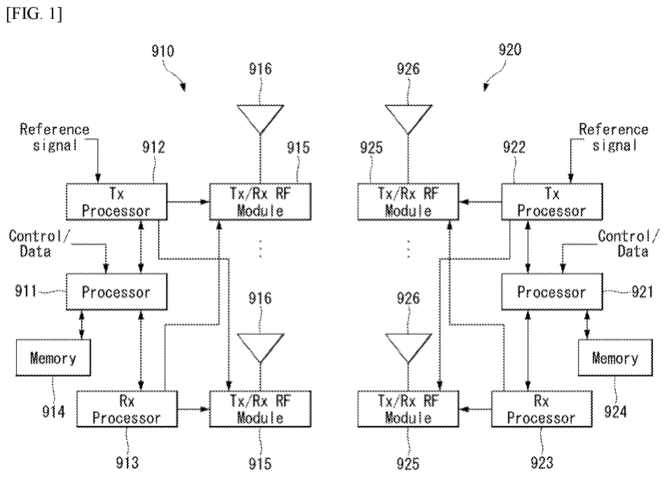

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

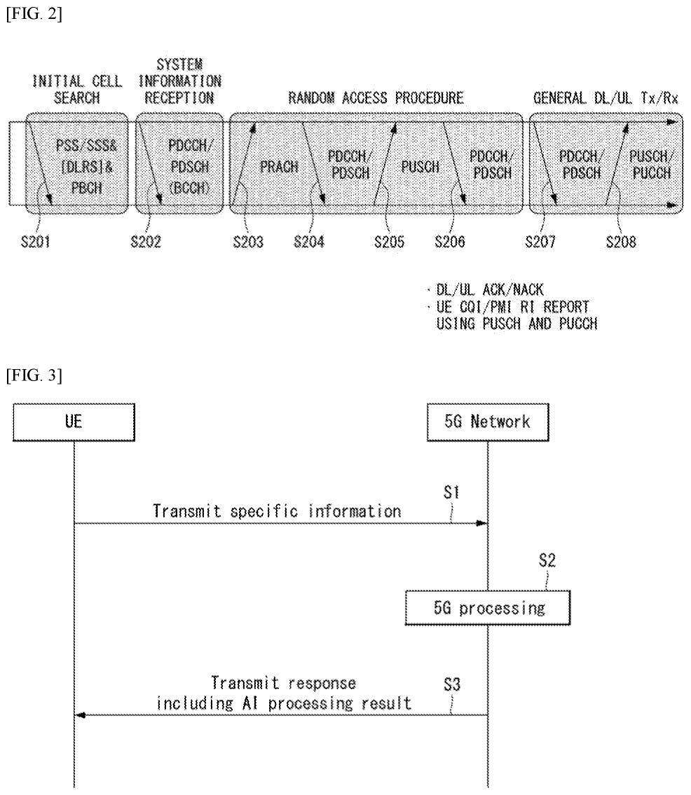

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and 5205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the OSI-S SB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles using 5G Communication

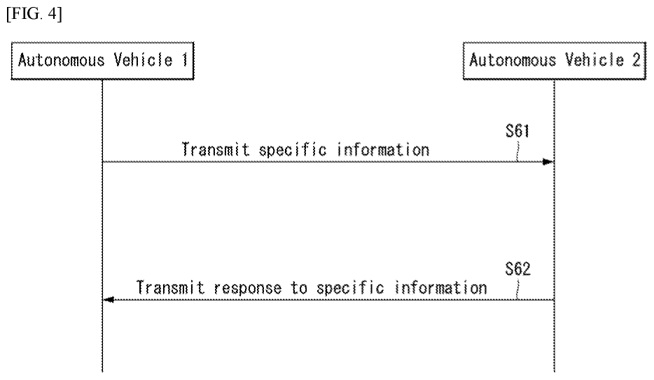

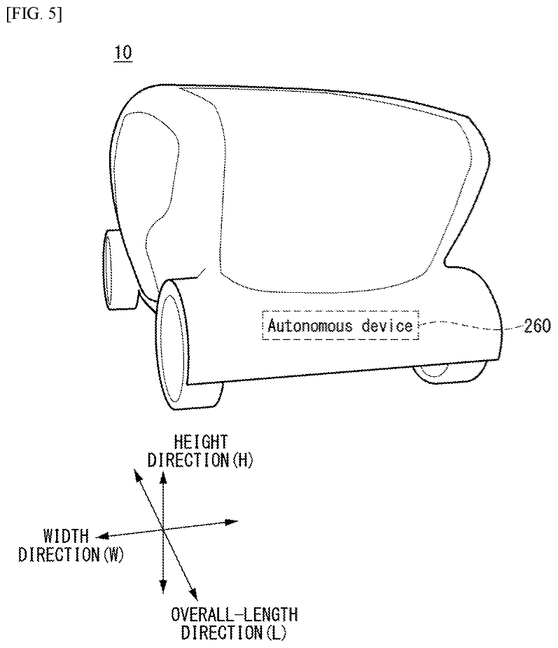

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

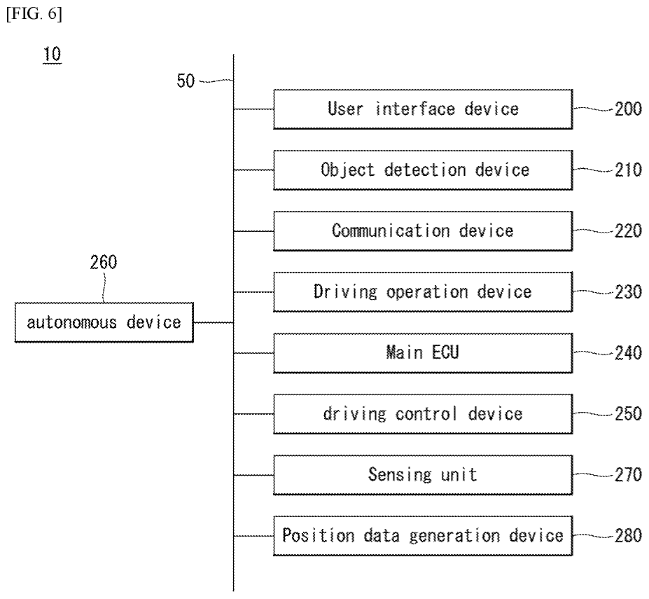

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

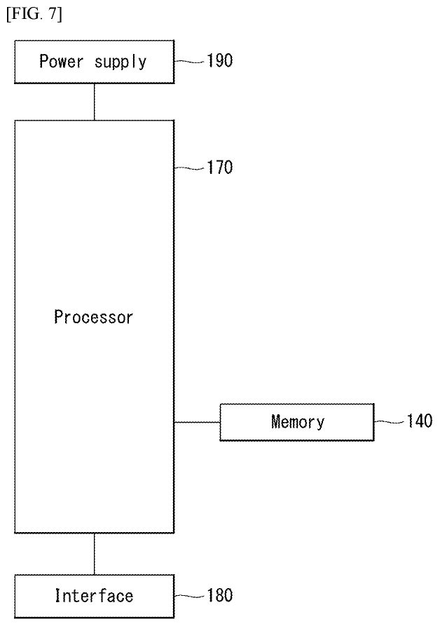

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170.

Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

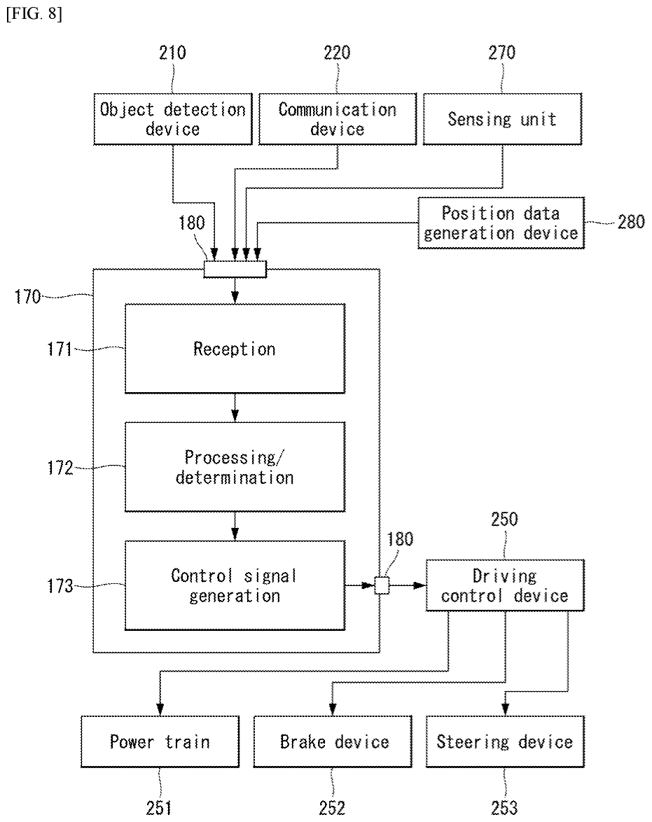

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenarios

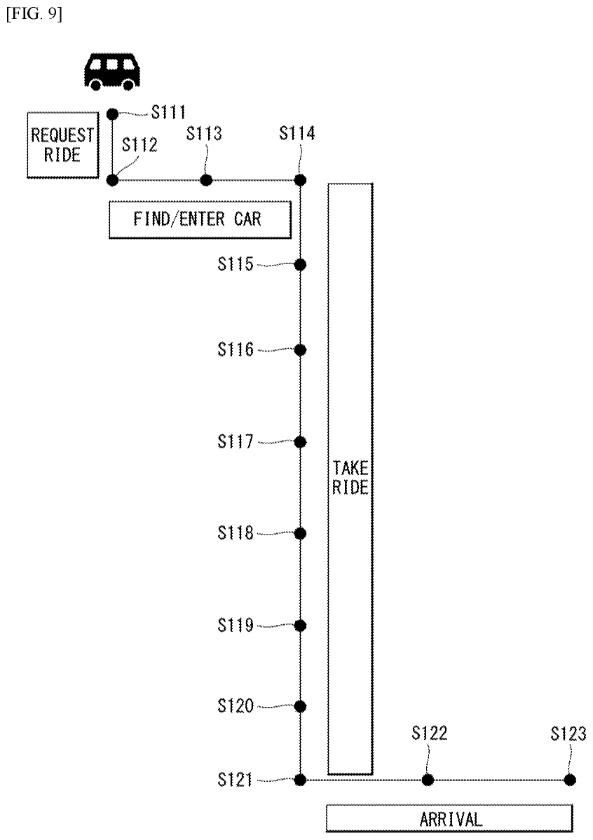

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system may further include at least one guide light. The guide light can be disposed on the floor of the cabin. When a user riding in the vehicle is detected, the cabin system can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

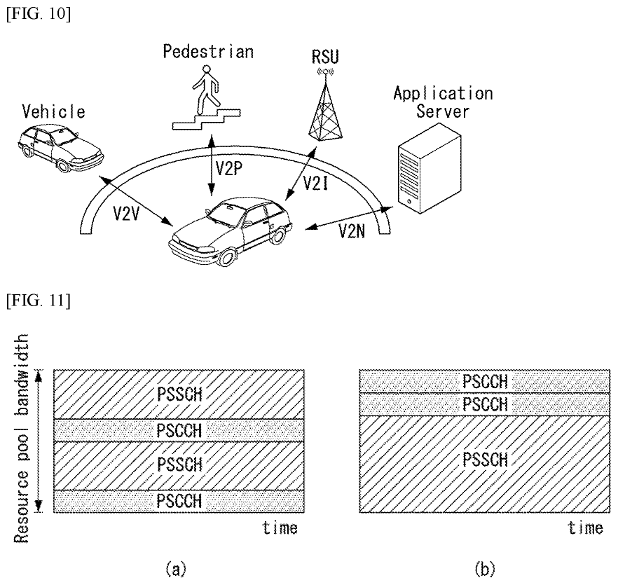

FIG. 10 illustrates V2X communication to which the present disclosure is applicable.

V2X communication includes communication between a vehicle and any entity, such as V2V (Vehicle-to-Vehicle) referring to communication between vehicles, V2I (Vehicle to Infrastructure) referring to communication between a vehicle and an eNB or a road side unit (RSU), V2P (Vehicle-to-Pedestrian) referring to communication between a vehicle and a UE carried by a person (a pedestrian, a bicycle driver, or a vehicle driver or passenger), and V2N (vehicle-to-network).

V2X communication may refer to the same meaning as V2X sidelink or NR V2X or refer to a wider meaning including V2X sidelink or NR V2X.

V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

V2X communication can be provided through a PC5 interface and/or a Uu interface. In this case, specific network entities for supporting communication between vehicles and every entity can be present in wireless communication systems supporting V2X communication. For example, the network entities may be a BS (eNB), a road side unit (RSU), a UE, an application server (e.g., traffic safety server) and the like.

Further, a UE which performs V2X communication may refer to a vehicle UE (V-UE), a pedestrian UE, a BS type (eNB type) RSU, a UE type RSU and a robot including a communication module as well as a handheld UE.

V2X communication can be directly performed between UEs or performed through the network entities. V2X operation modes can be categorized according to V2X communication execution methods.

V2X communication is required to support pseudonymity and privacy of UEs when a V2X application is used such that an operator or a third party cannot track a UE identifier within an area in which V2X is supported.

The terms frequently used in V2X communication are defined as follows.

RSU (Road Side Unit): RSU is a V2X service enabled device which can perform transmission/reception to/from moving vehicles using a V2I service. In addition, the RSU is a fixed infrastructure entity supporting a V2X application and can exchange messages with other entities supporting the V2X application. The RSU is a term frequently used in conventional ITS specifications and is introduced to 3GPP specifications in order to allow documents to be able to be read more easily in ITS industry. The RSU is a logical entity which combines V2X application logic with the function of a BS (BS-type RSU) or a UE (UE-type RSU).

V2I service: A type of V2X service having a vehicle as one side and an entity belonging to infrastructures as the other side.

V2P service: A type of V2X service having a vehicle as one side and a device carried by a person (e.g., a pedestrian, a bicycle rider, a driver or a handheld UE device carried by a fellow passenger) as the other side.

V2X service: A 3GPP communication service type related to a device performing transmission/reception to/from a vehicle.

V2X enabled UE: UE supporting V2X service.

V2V service: A V2X service type having vehicles as both sides.

V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

FIG. 11 illustrates a resource allocation method in siderink in which V2X is used.

On sidelink, different physical sidelink control channels (PSCCHs) may be spaced and allocated in the frequency domain and different physical sidelink shared channels (PSSCHs) may be spaced and allocated. Alternatively, different PSCCHs may be continuously allocated in the frequency domain and PSSCHs may also be continuously allocated in the frequency domain.

NR V2X

To extend 3GPP platform to auto industry during 3GPP release 14 and 15, support for V2V and V2X services has been introduced in LTE.

Requirements for support for enhanced V2X use cases are arranged into four use example groups.

(1) Vehicle platooning enables dynamic formation of a platoon in which vehicles move together. All vehicles in a platoon obtain information from the leading vehicle in order to manage the platoon. Such information allows vehicles to travel in harmony rather than traveling in a normal direction and to move together in the same direction.

(2) Extended sensors allow vehicles, road side units, pedestrian devices and V2X application servers to exchange raw data or processed data collected through local sensors or live video images. A vehicle can enhance recognition of environment beyond a level that can be detected by a sensor thereof and can ascertain local circumstances more extensively and generally. A high data transfer rate is one of major characteristics.

(3) Advanced driving enables semi-automatic or full-automatic driving. Each vehicle and/or RSU share data recognized thereby and obtained from local sensors with a neighboring vehicle, and a vehicle can synchronize and adjust a trajectory or maneuver. Each vehicle shares driving intention with a neighboring traveling vehicle.

(4) Remote driving enables a remote driver or a V2X application to drive a remote vehicle for a passenger who cannot drive or cannot drive a remote vehicle in a dangerous environment. When changes are limited and routes can be predicted such as public transportation, driving based on cloud computing can be used. High reliability and low latency time are major requirements.

ID for performing V2X communication through PC5

Each UE has a Layer-2 identifier for V2X communication through at least one PC5. The Layer-2 identifier includes a source Layer-2 ID and a destination Layer-2 ID.

The source and destination Layer-2 IDs are included in a Layer-2 frame, and the Layer-2 frame is transmitted through a layer-2 link of PC5 which identifies a source and a destination of Layer-2.

A UE selects source and destination Layer-2 ID on the basis of a communication mode of V2X communication of PC5 of Layer-2 link. Different communication modes may have different source Layer-2 IDs.

When IP-based V2X communication is permitted, a UE is set such that it uses a link local IPv6 address as a source IP address. The UE can use this IP address for V2X communication of PC5 without sending a Neighbor Solicitation and Neighbor Advertisement message for duplicate address search.

If one UE has an activated V2X application that is supported in the current geographical area and requires personal information protection, a source Layer-2 ID may be changed over time and randomized such that a source UE (e.g., a vehicle) is traced or distinguished from other UEs only for a specific time. In the case of IP-based V2X communication, a source IP address needs to be changed over time and randomized.

Changes of IDs of a source UE need to be synchronized in a layer used in PCS. That is, if an application layer ID is changed, a source Layer-2 ID and a source IP address also need to be changed.

Broadcast Mode

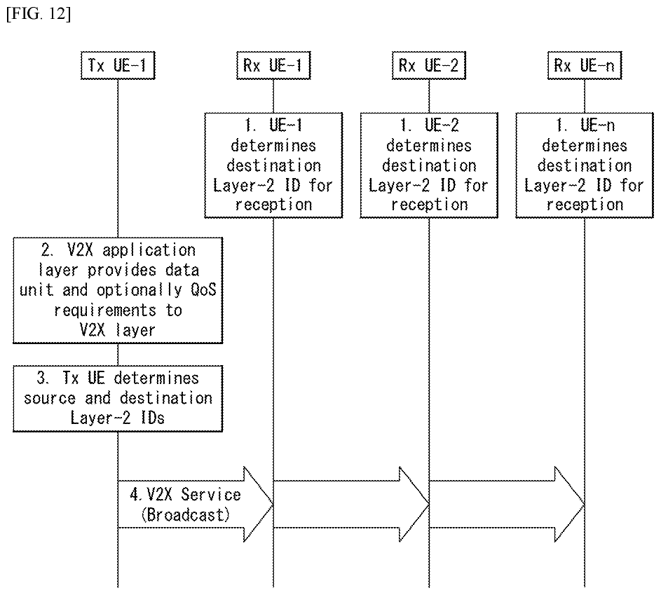

FIG. 12 is a diagram illustrating a procedure for a broadcast mode of V2X communication using PC5.

1. A reception UE determines a destination Layer-2 ID for broadcast reception. The destination Layer-2 ID is transmitted to an AS layer of the reception UE for reception.

2. A V2X application layer of a transmission UE provides a data unit and may provide application requirements.

3. The transmission UE determines a destination Layer-2 ID for broadcast. The transmission UE self-allocates a source Layer-2 ID.

4. One broadcast message transmitted by the transmission UE carries V2X service data using a source Layer-2 ID and a destination Layer-2 ID.

The above-described 5G communication technology can be combined with methods proposed in the present disclosure which will be described layer and applied or supplemented to specify or clarify technical features of the methods proposed in the present disclosure.

Hereafter, various embodiments of the present disclosure will be described in detail with reference to the attached drawings.

When emergencies such as fire, crime, disaster and having a patient have occurred, emergency vehicles need to rapidly enter spots of emergencies. When an emergency has occurred in a metropolitan area, it may be difficult to rapidly cope with the situation because emergency vehicles have difficulty entering the spot due to parked vehicles and the like. When it is difficult to move parked vehicles to other places, an unnecessary time may be additionally required to drive emergency vehicles to the spot, cope with the situation and perform processing and transfer.

In the present disclosure, when an emergency has occurred, a server receives emergency vehicle dispatch information and information on the location of occurrence of the emergency, and autonomous vehicles stopped in areas around the location of occurrence of the emergency and on a route of dispatch of the emergency vehicle receive the emergency vehicle dispatch information. It is possible to park autonomous vehicles in a block a predetermined distance or longer from a route through which the emergency vehicle enters using autonomous driving and notify vehicle owners of each step in real time, and the emergency vehicle can rapidly enter the spot of the emergency.

Accordingly, the emergency vehicle can secure a space for entering the spot and rapidly enter the spot. Further, it is possible to prevent a parked vehicle from being damaged which may occur when the emergency vehicle copes with the situation and prevent a situation in which a driver of a parked vehicle cannot approach the parked vehicle.

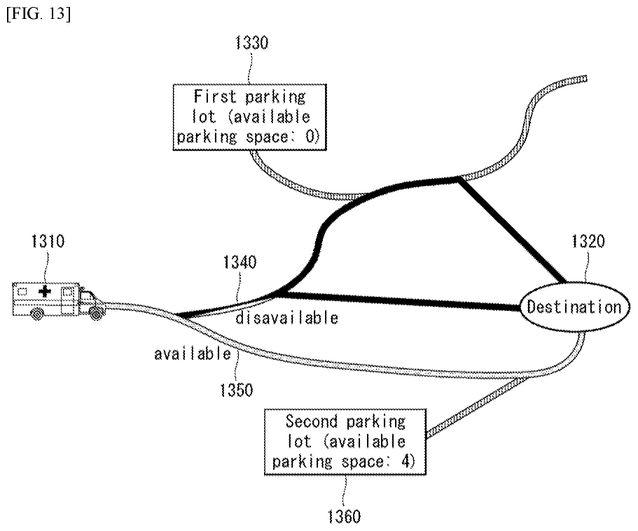

FIG. 13 shows an embodiment to which the present disclosure is applicable.

A server can assign an appropriate emergency vehicle 1310 upon determining that an emergency has occurred using a report of a person in the emergency, monitoring information, or the like. The server searches available routes to a destination 1320 at which the emergency has occurred on the basis of positional information of the emergency vehicle 1310. If there is an available route, the server can transmit information on the route to the emergency vehicle 1310 and the emergency vehicle 1310 can move to the destination 1320 using the available route.

If it is determined that there is no available route, the server transmits movement capability information request message to vehicles parked on routes which are connected to the destination 1320 but are not available for the emergency vehicle 1310 due to the parked vehicles. For this, information received from RSUs located on the corresponding routes, and traffic information and the like provided from a traffic server can be used.

The movement capability information request message may include positional information on parking lots connected to the corresponding routes and information on available parking spaces. For example, a vehicle parked on a first route 1340 can use a first parking lot 1330 and a vehicle parked on a second route 1350 can use a second parking lot 1360.

A vehicle determines movement capability thereof on the basis of the received movement capability information request message. That is, a vehicle parked on the first route 1340 can determine that movement capability thereof is not available on the basis of information representing that the first parking lot 1330 has no available parking space. Further, a vehicle parked on the second route 1350 can determine whether the vehicle can move to the second parking lot 1360 on the basis of information representing that the second parking lot 1360 has four available parking spaces and determine that movement capability thereof is available upon determining that the vehicle can move to the second parking lot 1360 and parking is available.

A plurality of vehicles may have been parked on the second route 1350. In this case, the closer a vehicle which needs to move to the second parking lot 1360 is to the second parking lot 1360, the higher its assignment priority is. Accordingly, a vehicle with a lower assignment priority may be determined to have no movement capability even when the second parking lot 1360 has available parking spaces.

The server determines whether the corresponding routes are available on the basis of movement capability information received from the vehicles parked on the routes.

For example, the first parking lot 1330 available for vehicles parked on the first route 1340 has no available parking space and thus movement capabilities of the vehicles parked on the first route 1340 are determined to be unavailable, and the server can determine that the state of the first route 1340 is unavailable on the basis of this. In the case of the second route 1350, if the second parking lot 1350 available for vehicles parked on the second route 1350 has four available parking spaces and the number of vehicles parked on the second route 1350 is 4 or less, movement capabilities of the vehicles are determined to be available and the state of the second route is determined to be available.

Furthermore, movement capabilities of vehicles can be reset by the server. The server can determine a shortest travel route through which the emergency vehicle 1310 can pass through routes blocked by parked vehicles on the basis of positional information of the vehicles parked on the routes and assign only vehicles parked on the shortest travel route to parking spaces. Accordingly, movement capabilities of vehicles can be reset and the reset movement capabilities can be included in a movement request message and transmitted to the vehicles.

The server can designate a route that provides a shortest estimated arrival time among routes set to an available state as an optimal route, transmit the information on the optimal route to the emergency vehicle 1310 and transmit a movement request message for requesting movement to available parking spaces to vehicles parked on the optimal route.

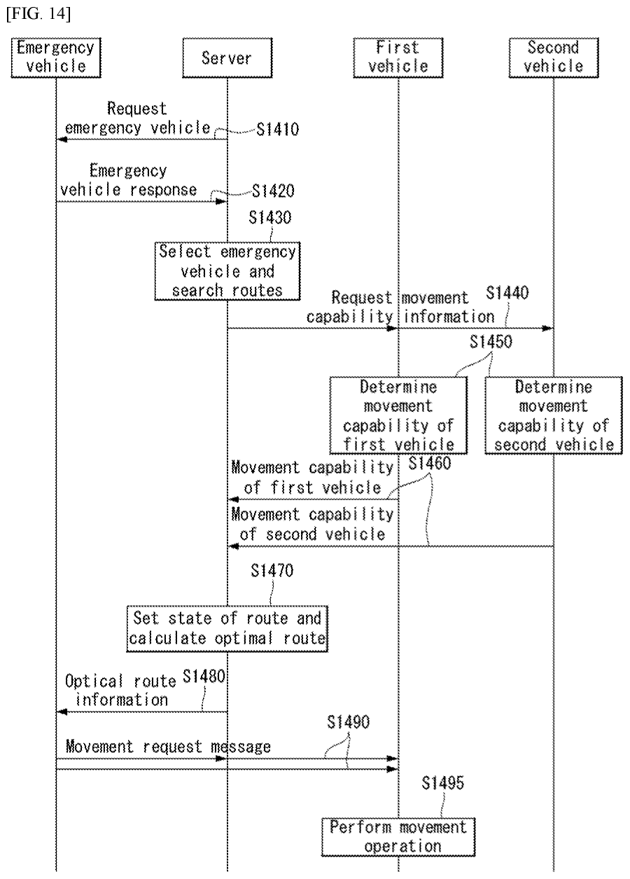

FIG. 14 shows an embodiment to which the present disclosure is applicable.

The server requests an emergency vehicle 1310 which can handle an emergency (S1410). A plurality of emergency vehicles 1310 may be present.

When the emergency vehicle 1310 which has received an emergency vehicle request message is available, the emergency vehicle 1310 transmits a response message to the server (S1420). The response message includes positional information of the emergency vehicle 1310.

The server selects an appropriate emergency vehicle 1310 according to a distance to the destination 1320 at which emergency has occurred, traffic information, emergency type and scale, and the like on the basis of the received response message and searches for a route to the destination on the basis of the positional information of the selected emergency vehicle 1310 (S1430). Such route search can be performed on the basis of a predetermined distance or a predetermined time. Further, the server can determine whether the searched route is currently available. For this, traffic information or parking information received from RSUs located on the route can be used.

If the searched route is not available, the server transmits the movement capability information request message to vehicles parked on the searched route (S1440). The movement capability information request message can include information about parking lots connected to the corresponding route. The information about parking lots includes positional information of the parking lots and the number of available parking spaces.

A vehicle determines movement capability thereof on the basis of the movement capability information request message (S1450).

The vehicle transmits movement capability information thereof to the server (S1460).

The server sets a state of the searched route on the basis of the received movement capability information and calculates an optimal route corresponding to a shortest estimated arrival time or a shortest distance among routes in an available state (S1470).

The server transmits the information on the calculated optimal route to the emergency vehicle 1310 (S1480).

The emergency vehicle 1310 which has received the optimal route information moves to the destination 1320 and can transmit a movement request message for moving a first vehicle parked on the optimal route through the server. Alternatively, the emergency vehicle can directly transmit the movement request message through a V2X message (S1490).

The first vehicle can move to a parking lot connected to the corresponding route upon reception of the movement request message (S1495).

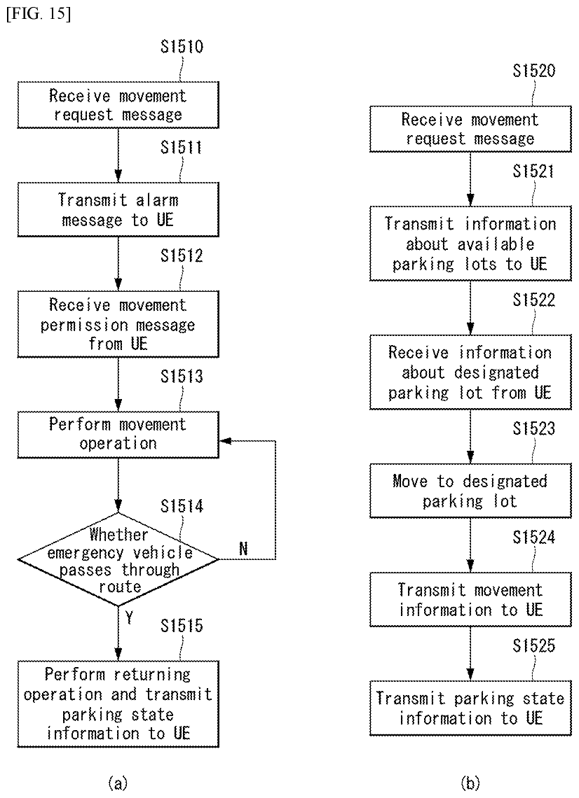

FIG. 15 illustrates operations of a parked vehicle to which the present disclosure is applicable.

FIG. 15(a) illustrates an operation of temporarily moving a parked vehicle. For example, the server can generate a route for the emergency vehicle 1310 through the embodiment of FIG. 15(a) when the server cannot calculate an available optimal route in the embodiment of FIG. 14. Alternatively, the embodiment of FIG. 15(a) may be combined with the embodiment of FIG. 14 and used together.

A vehicle receives a movement request message (S1510).

The vehicle can transmit an alarm message indicating reception of the movement request message to a UE thereof (S1511). If an optimal route is not present, an alarm message for temporarily moving a vehicle parked on a shortest route to the destination 1320 can be transmitted to a UE of the vehicle.

A user transmits a movement permission message to the vehicle through the UE and the vehicle receives the movement permission message (S1512).

The vehicle performs a movement operation (S1513). Here, the movement operation refers to an operation of temporarily deviating from the corresponding route, unlike the embodiment of FIG. 14.

The vehicle monitors whether the emergency vehicle 1310 has passed through the corresponding route (S1514). This can be performed through RSUs located on the corresponding route or determined through a V2X message transmitted from the emergency vehicle 1310.

When the emergency vehicle 1310 has passed through the corresponding route, the vehicle returns to the original location and transmits parking state information to the UE (S1515). When the vehicle cannot be parked at the previous parking position, the vehicle can be parked at a neighboring position. In this case, the parking state information can include information about a changed parking position. The UE can display a position at which the vehicle has been parked on a map through a display. The parking state information includes information on a position at which the vehicle has been parked.

FIG. 15(b) illustrates an operation of moving a vehicle which has received parking lot information.

The vehicle receives a movement request message (S520). The movement request message includes information on parking lots available for vehicles. The parking lot information includes positional information of parking lots, the names of the parking lots and the number of available parking spaces.

The vehicle transmits information on available parking lot information to a UE of the user (S1521). The UE can display a list including the names of parking lots available for the user.

The vehicle can receive information on a parking lot designated by the user among the available parking lots (S1522).

The vehicle moves to the designated parking lot (S1523).

The vehicle transmits movement information to the UE (S1524). Such movement information includes a travel state, positional information and movement route information of the vehicle. Accordingly, a user can determine a movement state of the vehicle.

The vehicle is parked in a designated parking lot and transmits parking state information to the UE (S1525).

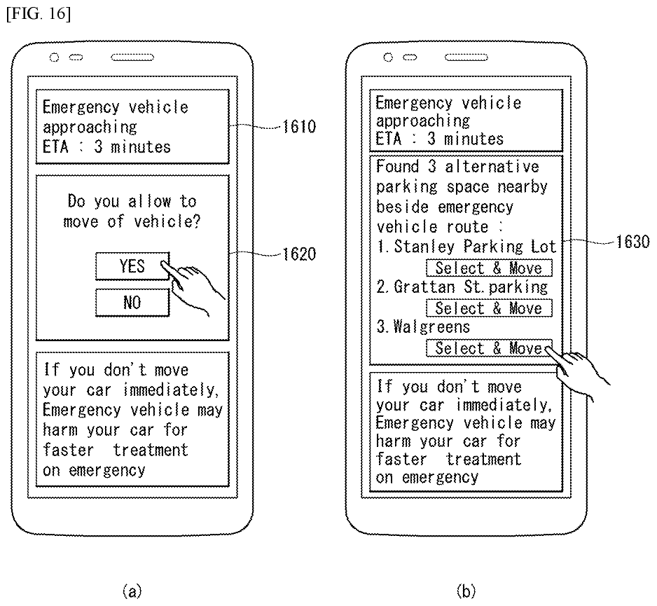

FIG. 16 shows an embodiment of a UE to which the present disclosure is applicable.

FIG. 16(a) illustrates a case in which the UE receives an alarm message (S1511). A movement request message received by the UE includes information on an estimated time of arrival of an emergency vehicle at a position at which the vehicle of the UE user is parked. The UE can display an estimated time of arrival (ETA) of the emergency vehicle to the user through a display (1610). Further, the user can notify the vehicle whether an operation of moving the corresponding vehicle can be permitted using button input through the display (1620). When the vehicle receives a movement permission message (S1512), the vehicle can perform a movement operation.

FIG. 16(b) illustrates a case in which the UE receives information about available parking lots (S1521). The UE can receive information about available parking lots from a server and display a list of available parking lots to the user through the display (1630). The user can select a parking lot to which the vehicle will be moved from the list through a button displayed on the display and the vehicle can perform a movement operation to the parking lot selected by the user.

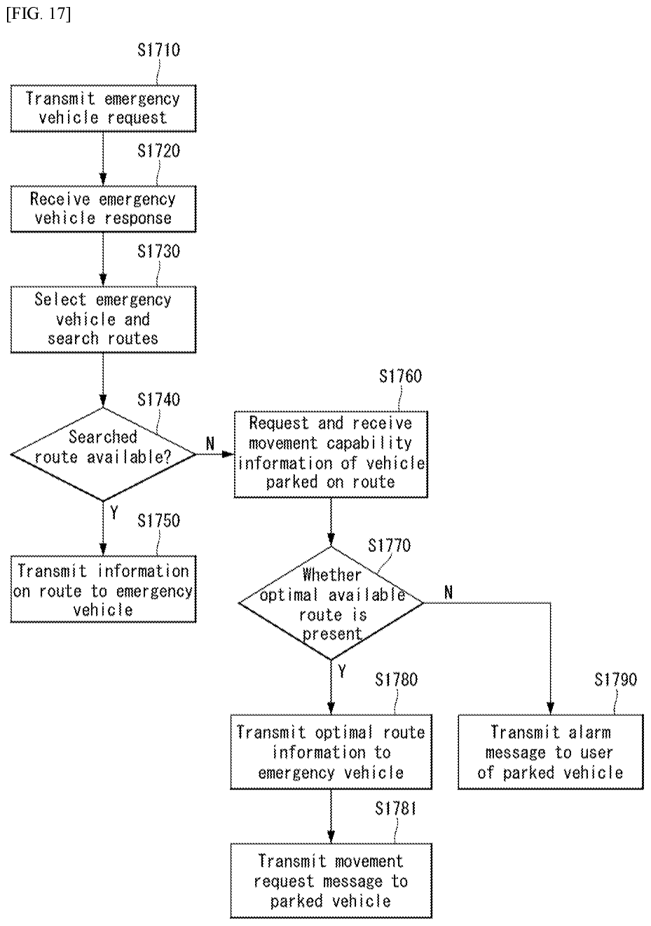

FIG. 17 shows an embodiment of a server to which the present disclosure is applicable.

The server transmits an emergency vehicle request message to available emergency vehicles 1310 (S1710).

When emergency vehicles 1310 which have received the request message are in an operable state, the emergency vehicles 1310 transmit response messages and the server receives the response messages (S1720).

The server selects an appropriate emergency vehicle 1310 in order to handle an emergency and searches for a route connected to a destination 1320 at which the emergency has occurred on the basis of positional information of the emergency vehicle 1310 (S1730).

The server determines whether the searched route is available (S1740). The searched route can be filtered with a time and a distance within predetermined ranges. Whether the searched route is available is based on whether the emergency vehicle 1310 can arrive at the destination 1320 using the route. When the corresponding route is not available due to parked vehicles, the searched route can be determined to be unavailable. For this determination, RSUs installed on the route or traffic information about the route can be used.

If the searched route is determined to be available, the server transmits the information on the available route to the emergency vehicle 1310 (S1750). The emergency vehicle 1310 can arrive at the destination using the route.

If all searched routes are unavailable, the server requests and receives movement capability information on vehicles parked on the searched routes (S1760).

The server determines presence or absence of an optimal available route on the basis of the received movement capability information (S1770).

When there is an optimal available route, the server transmits information on the optimal route to the emergency vehicle 1310 (S1780).

The server transmits a movement request message to vehicles parked on the optimal available route (S1781).

When an optimal available route is not present, the server transmits an alarm message to users of vehicles parked on a shortest route to the destination 1320 using UEs of the users (S1790). Upon reception of the alarm message, the parked vehicles can perform a temporary movement operation through the embodiment of FIG. 15(a).

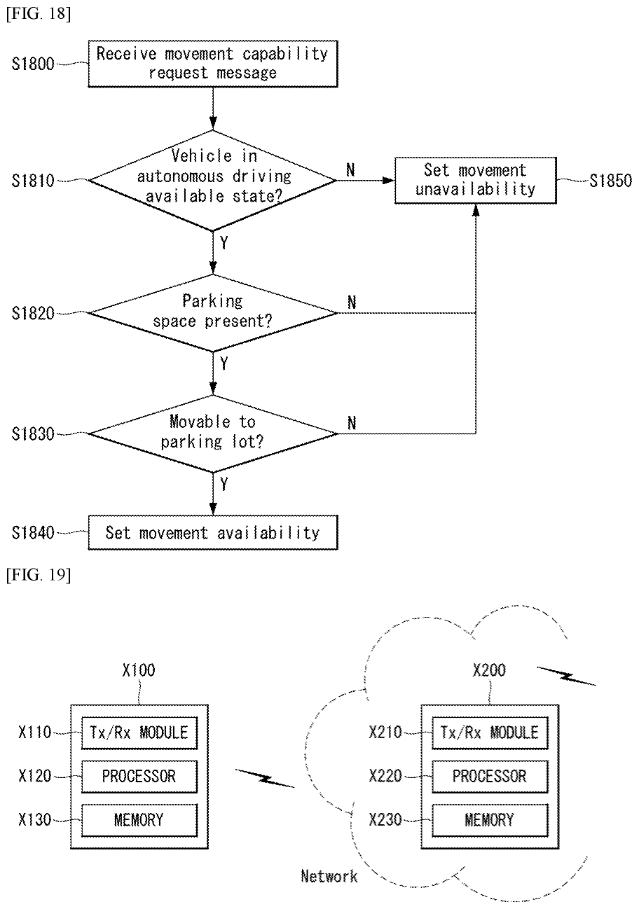

FIG. 18 illustrates a vehicle movement capability setting method to which the present disclosure is applicable.

When a vehicle receives a movement capability request message (S1800), the vehicle determines whether the vehicle is in an autonomous driving available state (S1810). For example, if a battery state for autonomous driving is not sufficient or full autonomous driving cannot be supported, the vehicle can be determined to be in an autonomous driving unavailable state.

Presence or absence of a parking space available for the vehicle is determined (S1820). For this, the aforementioned information about available parking lots can be shared by vehicles parked around the vehicle, and available parking spaces can be reserved for vehicles in the order of distance from the corresponding parking lot.

When an available parking space is present, it is determined whether the vehicle can move to the parking space (S1830). If parked vehicles having no movement capability are present on the route to the parking lot, the corresponding vehicle cannot move to the parking lot even if the available parking space is present and thus can be set to a movement unavailable state (S1850).

A vehicle that satisfies the aforementioned conditions can be set to a movement available state (S1840).

Apparatus to Which Present Disclosure is Applicable

Referring to FIG. 19, a server X200 according to a proposed embodiment may be an MEC server or a cloud server and may include a communication module X210, a processor X220 and a memory X230. The communication module X210 may be called a radio frequency (RF) unit. The communication module X210 can be configured to transmit various signals, data and information to external devices and to receive various signals, data and information from external devices. The server X200 can be connected to external devices in wired and/or wireless manners. The communication module X210 may be separated into a transmitter and a receiver. The processor X220 can control overall operation of the server X200 and can be configured to execute a function of processing information to be transmitted/received between the server X200 and external devices. Further, the processor X220 can be configured to perform a server operation proposed in the present disclosure. The processor X220 can control the communication module X210 to transmit data or messages to a UE or other vehicles or other servers according to proposition of the present disclosure. The memory X230 can store processed information for a predetermined time and can be replaced by a component such as a buffer.

Detailed configurations of a UE X100 and the server X200 can be realized such that the above-described various embodiments of the present disclosure can be independently applied or two or more thereof can be simultaneously applied, and redundant description is omitted for clarity.

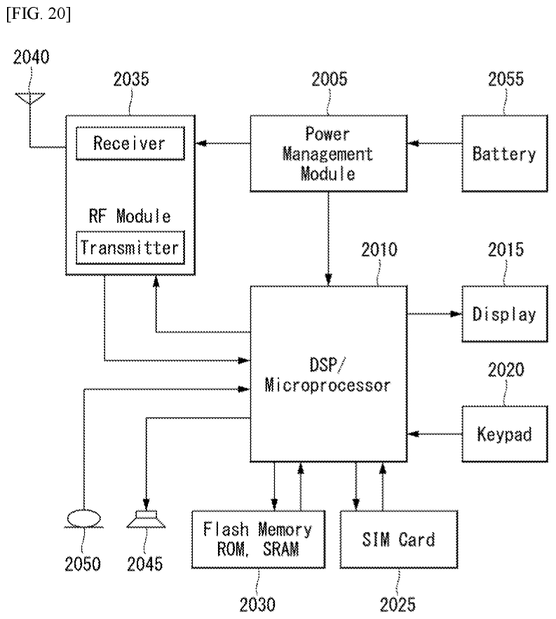

FIG. 20 is a block diagram of a communication apparatus according to an embodiment of the present disclosure. Particularly, FIG. 20 is a diagram illustrating the UE of FIG. 19 in more detail.

Referring to FIG. 20, the UE may include a processor (or a digital signal processor (DSP)) 2010, an RF module (or an RF unit) 2035, a power management module 2005, an antenna 2040, a battery 2055, a display 2015, a keypad 2020, a memory 2030, a subscriber identification module (SIM) card 2025 (this is optional), a speaker 2045 and a microphone 2050. The UE may further include a single antenna or multiple antennas.

The processor 2010 implements the above-described functions, processes and/or methods. A wireless internet protocol layer can be implemented by the processor 2010.

The memory 2030 is connected to the processor 2010 and stores information related to operation of the processor 2010. The memory 2030 may be provided inside or outside the processor 2010 and connected to the processor 2010 through various known means.

A user input command information such as a telephone number by pressing (or touching) buttons of the keypad 2020 or according to voice activation using the microphone 2050. The processor 2010 receives the command information and executes an appropriate function such as calling the telephone number. Operational data can be extracted from the SIM card 2025 or the memory 2030. Further, the processor 2010 can display command information or operation information on the display 2015 such that the user recognizes the information or for convenience.

The RF module 2035 is connected to the processor 2010 and transmits and/or receives RF signals. The processor 2010 transmits command information to the RF module 2035 such that the RF module 2035 transmits an RF signal constituting voice communication data, for example, in order to initiate communication. The RF module 2035 includes a receiver and a transmitter for receiving and transmitting RF signals. The antenna 2040 serves to transmit and receive RF signals. When an RF signal is received, the RF module 2035 can transmit the RF signal such that the RF signal is processed by the processor 2010 and convert the RF signal into a baseband signal. The processed signal can be converted into audible or readable information output through the speaker 2045.

Embodiments to Which Present Disclosure is Applicable

### Embodiment 1

A method for moving a parked vehicle for an emergency vehicle in autonomous driving systems, including: searching for a route connecting a location of the emergency vehicle and an emergency occurrence spot; determining whether the route is available with respect to the parked vehicle; requesting information about a movement capability of the parked vehicle when the route is not available for the emergency vehicle; receiving the information about the movement capability from the parked vehicle; setting a state of the route on the basis of the information about the movement capability and determining an optimal route set to a state indicating availability and providing a shortest estimated time of arrival at the emergency occurrence spot; and transmitting information about the optimal route to the emergency vehicle,

wherein the information about the movement capability indicates whether the parked vehicle can move according to autonomous driving, the availability indicates that the emergency vehicle can pass through the route according to movement of the parked vehicle, and the emergency vehicle moves to the emergency occurrence spot through the optimal route.

### Embodiment 2

In embodiment 1,

the method further includes: transmitting a request message for requesting dispatch of the emergency vehicle; receiving a response message to the request message from the emergency vehicle; and determining the emergency vehicle on the basis of the response message,

wherein the request message is transmitted to one or more emergency vehicles and the response message includes positional information of the emergency vehicle.

### Embodiment 3

In embodiment 1,

the method further includes transmitting a movement request message to the parked vehicle,

wherein the movement request message is for moving the parked vehicle parked on the optimal route.

### Embodiment 4

In embodiment 1,

the method further includes transmitting positional information of a parking lot to which the parked vehicle can move and parking space information of the parking lot to the parked vehicle,

wherein the movement capability is set by the parked vehicle on the basis of the positional information and the parking space information.

### Embodiment 5

In embodiment 1,

the method further includes transmitting information about the route to the emergency vehicle when the route is available for the emergency vehicle,

wherein the emergency vehicle moves to the emergency occurrence spot through the route.

### Embodiment 6

In embodiment 1,

the information about the movement capability indicates movement unavailability when a battery state for movement of the parked vehicle is not sufficient or the parked vehicle does not support autonomous driving.

### Embodiment 7

In embodiment 4,

the information about the movement capability includes positional information of the parked vehicle, and the movement capability is reset by a server on the basis of the positional information of the parked vehicle.

### Embodiment 8

In embodiment 3,

it is determined whether the parked vehicle is movable through a UE of a user.

### Embodiment 9

In embodiment 4,

a parking lot available for the parked vehicle is set through a UE of a user.

### Embodiment 10

In embodiment 1,

the method further includes transmitting a message for moving the parked vehicle to a UE of a user of the parked vehicle when the optimal route is not determined.

### Embodiment 11

A method for moving a parked vehicle, by a UE, for an emergency vehicle in autonomous driving systems, comprising:

receiving, from the parked vehicle, an alarm message indicating that movement of the parked vehicle has been requested; displaying the alarm message on a display of the UE; receiving a permission of movement of the parked vehicle from a user through an input button displayed on the display; and transmitting a permission message indicating the permission of movement to the parked vehicle,

wherein the alarm message includes a time estimated to be taken for the emergency vehicle to arrive at a location of the parked vehicle, and the parked vehicle performs a movement operation on the basis of the permission message.

### Embodiment 12

In embodiment 11,

the method further includes: receiving information about parking lots available for the parked vehicle from the parked vehicle; and displaying the information about the parking lots on the display,

wherein the information about the parking lots includes positional information, names and the number of available parking spaces of the parking lots, and the parked vehicle can arrive at the parking lots through autonomous driving.

### Embodiment 13

In embodiment 12,

the displaying of the information about the parking lots includes displaying a list including the names of the parking lots on the display.

### Embodiment 14

In embodiment 13,

the method further includes: selecting a parking lot to which the parked vehicle will move by the user through an input button displayed on the display; and transmitting, to the parked vehicle, information about the parking lot to which the parked vehicle will move,

wherein the parked vehicle performs a movement operation on the basis of information on the parking lot to which the parked vehicle will move.

### Embodiment 15

In embodiment 11,

the method further includes: receiving parking state information from the parked vehicle; and displaying a position at which the parked vehicle is parked on a map through the display on the basis of the parking state information,

wherein the parking state information includes information on the position at which the parked vehicle is parked.

### Embodiment 16

A UE for moving a parked vehicle for an emergency vehicle in autonomous driving systems, including: a communication module; a display; a memory; and a processor configured to control the communication module, the display and the memory,

wherein the processor is configured:

to receive, from the parked vehicle, an alarm message indicating that movement of the parked vehicle has been requested through the communication module; to display the alarm message on the display; to receive a permission of movement of the parked vehicle from a user through an input button displayed on the display; and to transmit a permission message indicating the permission of movement to the parked vehicle through the communication module,

wherein the alarm message includes a time estimated to be taken for the emergency vehicle to arrive at a location of the parked vehicle, and the parked vehicle performs a movement operation on the basis of the permission message.

### Embodiment 17

In embodiment 16,

the processor is configured to receive information about parking lots available for the parked vehicle from the parked vehicle through the communication module and to display the information about the parking lots on the display,

wherein the information about the parking lots includes positional information, names and the number of available parking spaces of the parking lots, and the parked vehicle can arrive at the parking lots through autonomous driving.

### Embodiment 18

In embodiment 17,

the processor is configured to display a list including the names of the parking lots on the display.

### Embodiment 19

In embodiment 18,

the processor is configured to select a parking lot to which the parked vehicle will move by the user through an input button displayed on the display, to transmit, to the parked vehicle, information about the parking lot to which the parked vehicle will move,

wherein the parked vehicle performs a movement operation on the basis of information on the parking lot to which the parked vehicle will move.

### Embodiment 20:

In embodiment 16,

the processor is configured to receive parking state information from the parked vehicle through the communication module and to display a position at which the parked vehicle is parked on a map through the display on the basis of the parking state information,

wherein the parking state information includes information on the position at which the parked vehicle is parked.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present disclosure without departing from the spirit or scope of the invention described in the appended claims. For example, each component described in detail in embodiments can be modified. In addition, differences related to such modifications and applications should be interpreted as being included in the scope of the present disclosure defined by the appended claims.

What is claimed is:

1. A method for moving a parked vehicle for an emergency vehicle in autonomous driving systems, comprising:
searching for a route connecting a location of the emergency vehicle and an emergency occurrence spot;
determining based on the route is available with respect to the parked vehicle;
requesting information about a movement capability of the parked vehicle when the route is not available for the emergency vehicle;
receiving the information about the movement capability from the parked vehicle;
setting a state of the route on the basis of the information about the movement capability and determining an optimal route set to a state indicating availability and providing a shortest estimated time of arrival at the emergency occurrence spot; and
transmitting information about the optimal route to the emergency vehicle,
wherein the information about the movement capability indicates based on the parked vehicle can move according to autonomous driving, the availability indicates that the emergency vehicle can pass through the route according to movement of the parked vehicle, and the emergency vehicle moves to the emergency occurrence spot through the optimal route.

2. The method of claim 1, further comprising:
transmitting a request message for requesting dispatch of the emergency vehicle;
receiving a response message to the request message from the emergency vehicle; and
determining the emergency vehicle on the basis of the response message,
wherein the request message is transmitted to one or more emergency vehicles and the response message includes positional information of the emergency vehicle.

3. The method of claim 1, further comprising transmitting a movement request message to the parked vehicle,
wherein the movement request message is for moving the parked vehicle parked on the optimal route.

4. The method of claim 1, further comprising transmitting positional information of a parking lot to which the parked vehicle can move and parking space information of the parking lot to the parked vehicle,
wherein the movement capability is set by the parked vehicle on the basis of the positional information and the parking space information.

5. The method of claim 1, further comprising transmitting information about the route to the emergency vehicle when the route is available for the emergency vehicle,
wherein the emergency vehicle moves to the emergency occurrence spot through the route.

6. The method of claim 1, wherein the information about the movement capability indicates movement unavailability when a battery state for movement of the parked vehicle is not sufficient or the parked vehicle does not support autonomous driving.

7. The method of claim 4, wherein the information about the movement capability includes positional information of the parked vehicle, and the movement capability is reset by a server on the basis of the positional information of the parked vehicle.

8. The method of claim 3, wherein it is determined whether the parked vehicle is movable through a UE of a user.

9. The method of claim 4, wherein a parking lot available for the parked vehicle is set through a UE of a user.

10. The method of claim 1, further comprising transmitting a message for moving the parked vehicle to a UE of a user of the parked vehicle when the optimal route is not determined.

11. A method for moving a parked vehicle, by a UE, for an emergency vehicle in autonomous driving systems, the method comprising:
receiving, from the parked vehicle, an alarm message indicating that movement of the parked vehicle has been requested;
displaying the alarm message on a display of the UE;
receiving a permission of movement of the parked vehicle from a user through an input button displayed on the display; and
transmitting a permission message indicating the permission of movement to the parked vehicle,
wherein the alarm message includes a time estimated to be taken for the emergency vehicle to arrive at a location of the parked vehicle, and the parked vehicle performs a movement operation on the basis of the permission message.

12. The method of claim 11, further comprising:
receiving information about parking lots available for the parked vehicle from the parked vehicle; and
displaying the information about the parking lots on the display,
wherein the information about the parking lots includes positional information, names and the number of available parking spaces of the parking lots, and the parked vehicle can arrive at the parking lots through autonomous driving.

13. The method of claim 12, wherein the displaying of the information about the parking lots comprises displaying a list including the names of the parking lots on the display.

14. The method of claim 13, further comprising:
selecting a parking lot to which the parked vehicle will move by the user through an input button displayed on the display; and
transmitting, to the parked vehicle, information about the parking lot to which the parked vehicle will move,
wherein the parked vehicle performs a movement operation on the basis of information on the parking lot to which the parked vehicle will move.

15. The method of claim 11, further comprising:
receiving parking state information from the parked vehicle; and
displaying a position at which the parked vehicle is parked on a map through the display on the basis of the parking state information,
wherein the parking state information includes information on the position at which the parked vehicle is parked.

16. A UE for moving a parked vehicle for an emergency vehicle in autonomous driving systems, the UE comprising:
a transceiver;
a display;
a memory; and
a processor configured to control the transceiver, the display and the memory,
wherein the processor is configured to receive, from the parked vehicle, an alarm message indicating that movement of the parked vehicle has been requested through the transceiver, to display the alarm message on the display, to receive a permission of movement of the parked vehicle from a user through an input button displayed on the display and to transmit a permission message indicating the permission of movement to the parked vehicle through the transceiver,
wherein the alarm message includes a time estimated to be taken for the emergency vehicle to arrive at a location of the parked vehicle, and the parked vehicle performs a movement operation on the basis of the permission message.

17. The UE of claim 16, wherein the processor is configured to receive information about parking lots available for the parked vehicle from the parked vehicle through the transceiver and to display the information about the parking lots on the display,
wherein the information about the parking lots includes positional information, names and the number of available parking spaces of the parking lots, and the parked vehicle can arrive at the parking lots through autonomous driving.

18. The UE of claim 17, wherein the processor is configured to display a list including the names of the parking lots on the display.

19. The UE of claim 18, wherein the processor is configured to select a parking lot to which the parked vehicle will move by the user through an input button displayed on the display, to transmit, to the parked vehicle, information about the parking lot to which the parked vehicle will move,
wherein the parked vehicle performs a movement operation on the basis of information on the parking lot to which the parked vehicle will move.

20. The UE of claim 16, wherein the processor is configured to receive parking state information from the parked vehicle through the transceiver and to display a position at which the parked vehicle is parked on a map through the display on the basis of the parking state information,
wherein the parking state information includes information on the position at which the parked vehicle is parked.
